(19) United States
(12) Patent Application Publication
(10) Pub. No.: US 2015/0277447 A1
(43) Pub. Date: Oct. 1, 2015

(54) Pressure Independent Control Valve for Small Diameter Flow, Energy Use and/or Transfer

(71) Applicant: Bray International, Inc., Houston, TX (US)

(72) Inventor: Jim Schmidt, Houston, TX (US)

(21) Appl. No.: 14/671,839

(22) Filed: Mar. 27, 2015

Related U.S. Application Data
(60) Provisional application No. 61/971,999, filed on Mar. 28, 2014.

(51) Int. Cl. G05D 7/06; F16K 31/06; G01F 1/66

(52) U.S. Cl. CPC G05D 7/0635; G01F 1/66; F16K 31/0644

(57) ABSTRACT

A pressure independent control valve for small diameter applications for the purpose of regulating or maintaining a predetermined flow rate and/or energy usage/transfer within a pipe system is disclosed. A needle valve is inserted into a flow path where the flow path travels through the needle valve when the needle valve is in an open position. An actuator connects with the needle valve where the actuator is configured to move the needle valve between the open position and a closed position. The flow rate is determined from an ultrasonic sensor positioned in an inner wall of the pipe system or via differential pressure readings. The pipe system has a small diameter.

### STATEMENTS REGARDING FEDERALLY SPONSORED RESEARCH OR DEVELOPMENT

Not Applicable.

### NAMES OF THE PARTIES TO A JOINT RESEARCH AGREEMENT

Not Applicable.

### REFERENCE TO A “SEQUENCE LISTING”, A TABLE, OR A COMPUTER PROGRAM

Not Applicable.

### BACKGROUND

### Technical Field

Valve systems are used in heating, ventilation, and air-cooling (HVAC) pipe systems, including in regard to pressure independent control valves used to regulate and maintain the fluid flow rate and/or energy use/transfer of said pipe systems.

Conventional pressure independent control (PIC) or energy valves rely on the use of magnetic flow meters or sensors. Such systems often have low accuracy levels because magnetism-based sensors can fail to function properly due to debris, metal, or wayward ferrous materials in the pipe system. Further, such systems may rely on the use of valves to modulate the flow of fluid which are expensive to manufacture and thus increases the overall costs of these valve systems. In addition, at certain pipe diameters (for example two-and-a-half inches or smaller), some valves as implemented into prior systems may become prohibitively expensive to produce for a piping system unless purely mechanical designs are implemented.

Moreover, smaller diameter PIC valves that utilize such a purely mechanical design for low cost suffer limitations in operation and features.

Thus, a need exists for a low cost, better performing, and higher-accuracy alternative to the traditional small diameter pressure independent control valve systems.

BRIEF SUMMARY OF THE EMBODIMENTS

A pressure independent control valve for small diameter applications for the purpose of regulating or maintaining a predetermined flow rate and/or energy usage/transfer within a pipe system is disclosed. A needle valve is inserted into a flow path where the flow path travels through the needle valve when the needle valve is in an open position. An actuator connects with the needle valve where the actuator is configured to move the needle valve between the open position and a closed position. The flow rate is determined from an ultrasonic sensor positioned in an inner wall of the pipe system or via differential pressure readings. The pipe system has a small diameter.

The phrase ‘small diameter’ shall mean an internal or flow-way diameter ranging from about 0.5 to 2.5 inches (1.27 centimeters to 6.35 centimeters).

### BRIEF DESCRIPTION OF THE SEVERAL VIEWS OF THE DRAWINGS

The embodiments may be better understood, and numerous objects, features, and advantages made apparent to those skilled in the art by referencing the accompanying drawings. These drawings are used to illustrate only typical embodiments of this invention, and are not to be considered limiting of its scope, for the invention may admit to other equally effective embodiments. The figures are not necessarily to scale and certain features and certain views of the figures may be shown exaggerated in scale or in schematic in the interest of clarity and conciseness.

FIG. 1 depicts a perspective view of one embodiment of a pressure independent control valve system.

FIG. 2 depicts a top view of one embodiment of a pressure independent control valve system.

FIG. 3 depicts a cross sectional view of one embodiment of a pressure independent control valve system along line 3-3 of FIG. 2.

### DESCRIPTION OF EMBODIMENT(S)

The description that follows includes exemplary apparatus, methods, techniques, and instruction sequences that embody techniques of the inventive subject matter. However, it is understood that the described embodiments may be practiced without these specific details.

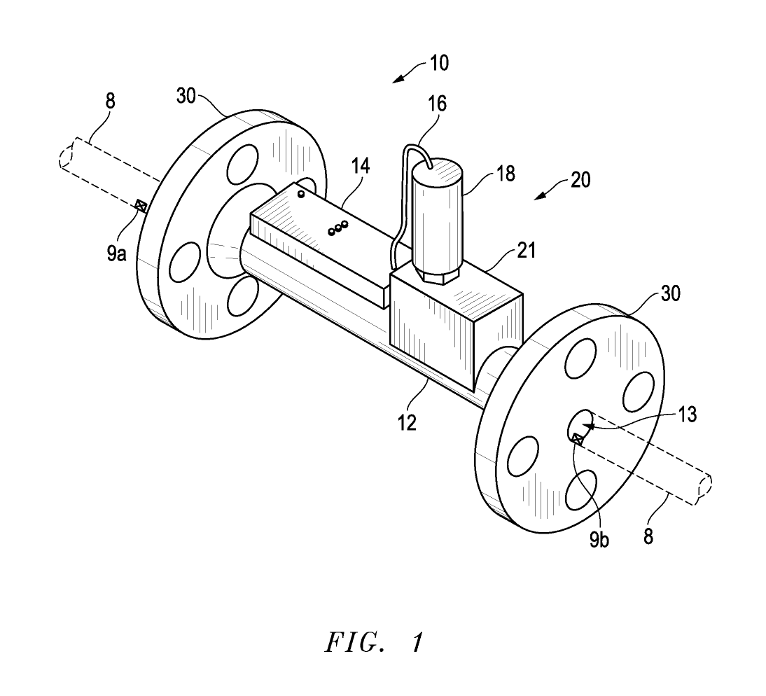

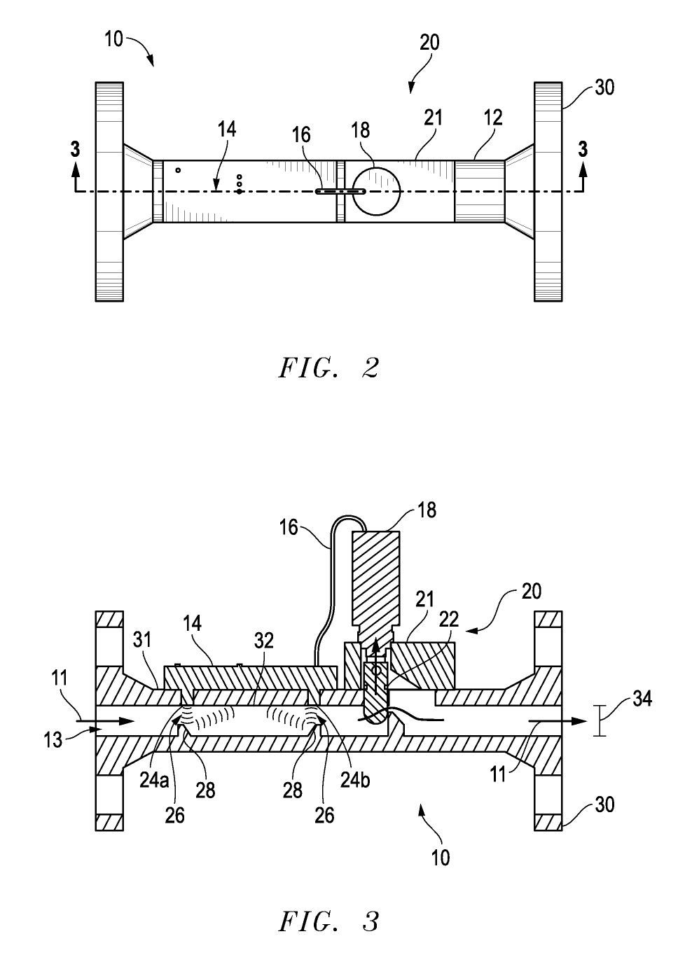

FIGS. 1 and 2 depict one embodiment of an improved small diameter pressure independent control valve system 10 in which a flow path 11 runs there through as part of a pipe system 8. The valve system 10 includes a spool or measurement conduit 12 which defines a flow chamber 13 through which flow path 11 travels into. Spool 12 may have flange connections 30 which connect to the rest of the pipe system 8. On the downstream end of valve system 10 is needle valve assembly 20, through which flow path 11 travels past to exit into the remainder of the pipe system 8. The fluid which travels along flow path 11 may be any type of fluid. For example, the fluid may be any fluid typically used within an HVAC system, including, but not limited to: water, or a water/glycol mixture; or the fluid may be any other type of fluid travelling through a pipe system 8.

Moreover, it is critical to the performance of the embodiment(s) described herein that the flow chamber 13 of spool 12 has an internal diameter 34 ranging from 0.5 to 2.5 inches (1.27 centimeters to 6.35 centimeters), i.e. small diameter. The relatively small internal diameter 34 (i.e. selected from a range within 0.5 to 2.5 inches) of the pipe system 8 is a critical factor as it relates to the embodiment(s) described herein because such small diameter systems have a pure mechanical design and/or expensive production costs. The present disclosure features electronic control, higher accuracy flow rate sensing, better performance, and low cost for small diameter pressure independent control valve systems.

Needle valve assembly 20 and spool 12 may be coupled to the pipe system 8 through flange connections 30. Needle valve assembly 20 includes a needle valve 22 (which flow path 11 travels there through when the needle valve 22 is in an open position) and a solenoid or small motor 18. Needle valve assembly 20 may further include a valve housing 21 mounted to the spool 12 to house and stabilize needle valve 22 and/or solenoid or small motor 18. Although needle valve 22 is actuated by a solenoid or small motor 18, needle valve 22 may be actuated by any type of electronic actuator best determined by one of ordinary skill in the art.

In the embodiment depicted within FIGS. 2-3, two ultrasonic sensors 24a and 24b are positioned in the wall 31 of spool 12, in such manner that transmitted ultrasonic signals 26 from one ultrasonic sensor 24a or 24b are received by the other respective ultrasonic sensor 24a or 24b. As depicted in FIG. 3, the ultrasonic signals 26 are directed towards a reflector 28, which bounces the ultrasonic signal 26 to the opposite ultrasonic sensor 24a or 24b. While ultrasonic sensors 24a and 24b are retained in the wall 31 of spool 12, ultrasonic sensors 24a and 24b may alternatively be retained in sensor supports (not illustrated) mounted to the external surface of spool 12. Further, ultrasonic sensors 24a and 24b are preferably flush with or slightly recessed into the interior surface 32 of spool 12 so as to not introduce additional disturbance, turbulence or variance into the flow path 11. Ultrasonic sensors 24a and 24b are ultrasonic sensors (comprising an ultrasonic flow meter) capable of both transmitting and receiving ultrasonic signals 26 in the form of ultrasonic waves or vibrations across the flow of fluid in flow chamber 13. Ultrasonic sensors 24a and 24b may also be positioned at an angle which may be increased or decreased to modify the distance or length traveled by the ultrasonic signal 26 through the fluid medium (the angle can vary depending upon the application e.g.: pipe diameter). Please see U.S. Provisional Patent Application No. 61/881,828 for additional information regarding possible sensor position arrangement, the entire disclosure of which is hereby incorporated by reference.

Further, ultrasonic sensors 24a and 24b may deliver data to electronic transducer processor 14 where the data are collected, recorded, compared, and calculated. The ultrasonic sensors 24a and 24b may communicate the data to electronic transducer processor 14 through wires 16 or other means, or may transmit the data wirelessly.

The electronic transducer processor 14 itself may be mounted onto the external surface of spool 12 as depicted in FIGS. 1-3, or may be located elsewhere within the valve system 10 or pipe system 8. For example, while the figures depict an electronic transducer processor 14 mounted on top of spool 12, electronic transducer processor 14 may be combined physically with the solenoid or small motor 18.

The electronic transducer processor 14 is generally implemented as electronic circuitry and processor-based computational components controlled by computer instructions stored in physical data-storage components, including various types of electronic memory and/or mass-storage devices. It should be noted, at the onset, that computer instructions stored in physical data-storage devices and executed within processors comprise the control components of a wide variety of modern devices, machines, and systems, and are as tangible, physical, and real as any other component of a device, machine, or system. Occasionally, statements are encountered that suggest that computer-instruction-implemented control logic is “merely software” or something abstract and less tangible than physical machine components. Those familiar with modern science and technology understand that this is not the case. Computer instructions executed by processors must be physical entities stored in physical devices. Otherwise, the processors would not be able to access and execute the instructions. The term “software” can be applied to a symbolic representation of a program or routine, such as a printout or displayed list of programming-language statements, but such symbolic representations of computer programs are not executed by processors. Instead, processors fetch and execute computer instructions stored in physical states within physical data-storage devices. Similarly, computer-readable media are physical data-storage media, such as disks, memories, and mass-storage devices that store data in a tangible, physical form that can be subsequently retrieved from the physical data-storage media.

A desired flow rate or control signal may be input into the electronic transducer processor 14 by an operator of the system, or alternatively, internally set by the manufacturer. When electronic transducer processor 14 determines that the flow rate in flow chamber 13 requires adjustment in order to maintain or modify to the desired flow rate or energy usage/transfer, the electronic transducer processor 14 communicates the necessary correction to solenoid or small motor 18 of the needle valve assembly 20 to change the position of needle valve 22 through wires 16 or wirelessly. The electronic transducer processor 14 may also directly communicate to and/or manipulate the solenoid or small motor 18 to the desired amount of actuation for the necessary movement of the needle valve 22 in order to regulate flow rate or volume. Upon receipt of instructions from electronic transducer processor 14, the position of needle valve 22 is adjusted accordingly by solenoid or small motor 18 such that the flow rate, flow volume or energy use/transfer is maintained at the predetermined, or set rate.

In one embodiment, the needle valve 22 spring is biased to a closed position. The electronic transducer processor 14 will manipulate solenoid or small motor 18 by increasing current flow to the solenoid or small motor 18 until the needle valve 22 begins to open. The current is gradually changed/increased until the needle valve 22 reaches an opening which balances the flow detected by the ultrasonic sensors 24a and 24b to or against the control signal set point. The current to the solenoid or small motor 18 is then increased or decreased to maintain the desired flow.

In an alternate embodiment, the needle valve 22 spring is biased to an open position. The electronic transducer processor 14 will manipulate solenoid or small motor 18 by changing/decreasing current flow to the solenoid or small motor 18 until the needle valve 22 begins to close. The current is gradually decreased until the needle valve 22 reaches a position which balances the flow detected by the ultrasonic sensors 24a and 24b to or against the control signal set point. The current to the solenoid or small motor 18 is then increased or decreased to maintain the desired flow.

To calculate the flow of fluid in the pipe system 8, the ultrasonic sensor 24a transmits an ultrasonic signal 26 across the flow path 11 to reflector 28. The reflector 28 reflects the ultrasonic signal 26 at an angle across flow path 11 to ultrasonic sensor 24b, which receives the ultrasonic signal 26. The period of time taken by ultrasonic signal 26 to reach ultrasonic sensor 24a or 24b is affected by the velocity of the fluid in flow path 11. The ultrasonic sensor 24b records the time at which the ultrasonic signal 26 is received and may also transmit an ultrasonic signal 26 back to ultrasonic sensor 24a. Ultrasonic sensor 24a also records the time at which any second ultrasonic signal 26 is received, and may transmit another ultrasonic signal 26 to ultrasonic sensor 24b. The back-and-forth transmittal and receipt process between the ultrasonic sensors 24a and 24b is continuously, periodically, or intermittently conducted, as desired, while the flow of the pipe system 8 is to be monitored and maintained at a predetermined or preferred flow rate as entered into electronic transducer processor 14. The data regarding the recorded times of transmission and receipt of the ultrasonic signals 26 of the valve system 10 are used to calculate the flow rate of the fluid in the flow chamber 13.

The ultrasonic sensors 24a and 24b return sensor output, or feedback, to the electronic transducer processor 14 through wires 16 or wireless communication. Based on this feedback, the electronic transducer processor 14 modifies the output control commands in order to achieve the specified flow rate or energy usage for the valve system 10.

In another embodiment to calculate the flow of fluid in the pipe system 8 (instead of or in addition to the ultrasonic sensors 24a, 24b), an inlet pressure sensor 9a and an outlet pressure sensor 9b may be used to measure or detect the differential pressure at the inlet and the outlet of the small diameter pressure independent control valve system 10. The differential flow may then be characterized and used to derive or determine the flow rate of the fluid in the pipe system 8.

While the embodiments are described with reference to various implementations and exploitations, it will be understood that these embodiments are illustrative and that the scope of the inventive subject matter is not limited to them. Many variations, modifications, additions and improvements are possible. For example, the techniques used herein may be applied to any valve system or assembly used for piping systems.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. An apparatus for maintaining a desired flow rate in a flow path within a pipe system, comprising:
a needle valve inserted into the flow path, wherein the flow path travels through the needle valve when the needle valve is in an open position;
an actuator in connection with the needle valve, wherein the actuator is configured to move the needle valve between the open position and a closed position;
a sensor selected from the group of sensors consisting of an ultrasonic sensor positioned in an inner wall of the pipe system wherein the ultrasonic sensor is configured to transmit and receive an ultrasonic signal, and an inlet pressure senor positioned proximate an inlet end of the pipe system and an outlet pressure sensor positioned downstream from the inlet pressure sensor; and
wherein the pipe system has a small diameter.

2. The apparatus of claim 1, further comprising a reflector mounted on the inner wall of the pipe system, wherein the reflector is configured to reflect the ultrasonic signal.

3. The apparatus of claim 1, wherein the actuator is an electronic actuator.

4. The apparatus of claim 3, wherein the actuator is a solenoid.

5. The apparatus of claim 4, further comprising an electronic transducer processor in data communication with the solenoid and the ultrasonic sensor.

6. The apparatus of claim 5, further comprising wires connecting the electronic transducer processor to the actuator.

7. The apparatus of claim 5, wherein the electronic transducer processor includes a data storage device.

8. The apparatus of claim 1, wherein the ultrasonic sensor is positioned at an angle to the flow path.

9. The apparatus of claim 1, wherein the needle valve is biased to the closed position.

10. The apparatus of claim 1, wherein the needle valve is biased to the open position.

11. A pressure independent control valve system, comprising:
a spool located within the valve system, having an inner diameter which defines a flow path having a small diameter;
a needle valve mounted to the spool, wherein the needle valve is configured to alter a flow rate when the needle valve is between an open position and a closed position of the needle valve;
an actuator configured to manipulate the needle valve between the open position and the closed position;
a sensor selected from the group of sensors consisting of an ultrasonic sensor mounted to an inner wall of the spool wherein the ultrasonic sensor is mounted in a position to transmit and receive an ultrasonic signal across the flow path; and an inlet pressure senor positioned proximate an inlet end of the pipe system and an outlet pressure sensor positioned downstream from the inlet pressure sensor;
a reflector mounted to the inner wall of the spool, wherein the reflector is mounted in such a position to reflect the ultrasonic signal to a second ultrasonic sensor; and
an electronic transducer processor in data communication with the actuator and the ultrasonic sensors.

12. A method for maintaining the flow rate in a pressure independent control valve system, comprising the steps of:
setting a desired flow rate into an electronic transducer processor;
supplying a flow of fluid into a flow chamber within the valve system, wherein the flow chamber has a small diameter;
transmitting an ultrasonic signal across the flow chamber, wherein the ultrasonic signal is transmitted by an ultrasonic sensor;
reflecting the ultrasonic signal;
receiving the ultrasonic signal with a second ultrasonic sensor;
determining a period of time for between the transmittal and the receipt of the ultrasonic signal;
calculating a present flow rate based on the period of time;
comparing the present flow rate to the desired flow rate; and
adjusting a position of a needle valve inserted into the flow of fluid to obtain the desired flow rate.

13. The method according to claim 12, further comprising the step of storing the desired flow rate and the present flow rate into a data storage device in communication with the electronic transducer processor.

14. The method according to claim 13, wherein the step of adjusting the position of the needle valve comprises actuating the needle valve with a solenoid actuator.

15. The method according to claim 14, wherein the step of adjusting the position of the needle valve further comprises changing a current flow to the solenoid actuator.

16. The method according to claim 15, further comprising the step of repeating the steps of:
transmitting an ultrasonic signal across the flow chamber, wherein the ultrasonic signal is transmitted by an ultrasonic sensor;
reflecting the ultrasonic signal;
receiving the ultrasonic signal with a second ultrasonic sensor;
determining a period of time for between the transmittal and the receipt of the ultrasonic signal; and
calculating a present flow rate based on the period of time.

17. The method according to claim 16, further comprising the steps of:
collecting a record of the calculated present flow rates based on the repetition; and
storing the record.

18. The method according to claim 17, further comprising the step of modifying the desired flow rate based on the stored record.

19. The method according to claim 18, further comprising the step of initially biasing the needle valve to an open position.

20. The method according to claim 18, further comprising the step of initially biasing the needle valve to a closed position.

21. The method according to claim 12 including using an inlet pressure senor positioned proximate an inlet end of a pipe system and an outlet pressure sensor positioned downstream from the inlet pressure sensor instead of or in addition to the ultrasonic sensors for detecting a differential pressure; and characterizing the flow rate of fluid in the pipe system for calculating the present flow rate.
